(19) United States
(12) Patent Application Publication
(10) Pub. No.: US 2026/0225393 A1
(43) Pub. Date: Aug. 6, 2026

(54) SECURITY ELEMENT

(71) Applicant: FASE S.R.L., Milano (IT)

(72) Inventors: James Snelling, Milano (IT); Orazio Audino, Milano (IT); Geremino Cammisa, Milano (IT); Luca Cimatti, Milano (IT); Andrea Iagallo, Milano (IT)

(73) Assignee: FASE S.R.L., Milano (IT)

(21) Appl. No.: 19/151,241

(22) PCT Filed: Feb. 6, 2024
(86) PCT No.: PCT/EP2024/052894

§ 371 Date: Jul. 25, 2025

(30) Foreign Application Priority Data
Feb. 8, 2023 (GB) 2301785.8

(51) Int. Cl. B42D 25/369; B41M 3/06; B41M 3/14; B42D 25/351; B42D 25/387; C09D 11/037; C09D 11/50; G02B 3/00

(52) U.S. Cl. CPC B42D 25/369; B42D 25/351; B42D 25/387; C09D 11/037; C09D 11/50; B41M 3/06; B41M 3/144; G02B 3/0075

(57) ABSTRACT

There is provided a security element, comprising: an optic layer; a metallic layer; and a printed magnetic ink layer. The security element optionally comprises a photoluminescent layer. Also provided is a security document comprising the security element and a substrate, wherein the security element is surface applied, or partially or wholly embedded in the substrate. The security element may provide enhanced anti-counterfeiting protection to security documents such as banknotes.

### CROSS-REFERENCE TO RELATED APPLICATIONS

This application claims priority to and is a 371 National Stage entry of PCT Application No. PCT/EP2024/052894, filed Sep. 24, 2024, which claims priority to United Kingdom Patent Application No. 2301785.8, filed Feb. 8, 2023, the entireties of which are hereby incorporated by reference.

### TECHNICAL FIELD

The present invention concerns a security element for use in a security document, for example a banknote, which provides enhanced anti-counterfeiting protection.

### BACKGROUND

Security elements are well known features applied to security documents in order to prevent counterfeiting and enable visual authentication of the documents. Security documents that require enhanced anti-counterfeiting protection include banknotes, passports, identification cards, credit cards, certificates of value, security labels, amongst others.

The use of security elements in security documents, for example banknotes, is widely known, with banknotes using such security elements having been in general circulation for many years. Security elements can be incorporated in the form of stripes, patches, or security threads, with a common example involving a polymer film provided with a continuous reflective metal layer formed by vacuum deposition.

Security elements may be surface applied, or partially or wholly embedded in a substrate, providing different viewing conditions depending on whether the security document is viewed in transmitted or reflected light. Security elements exhibiting optical effects which cannot be reproduced by standard means such as photocopying or scanning, include holograms and other diffractive devices, which exhibit different appearances, e.g., diffractive colours and holographic replays, at different viewing angles, and reflective elements that can be configured to display different intensities (i.e., brightness) at different viewing angles. Photocopies of such elements will not exhibit the same optically variable effects. The term “optically variable effect” means the device has an appearance which is different at different viewing angles.

Some security elements include focusing elements, such as micro-lenses, which act to create synthetic images that are observable to a user for authentication purposes. A typical synthetic-image device presents an array of small focusing elements and image objects created in different planes of a thin foil, as in WO2022220727. Other examples of security elements include watermarks and magnetically readable features.

Incorporation of security elements makes security documents difficult to forge, enhancing document security. This protects the documents from modern counterfeiting techniques such as colour separation, colour photocopy, computer-based scanning technology, and the like.

The incorporation of security elements into a security document is known in the art:

GB2536877 describes a security device comprising an array of elongate focusing structures, which have an optical footprint in which different elongate strips are directed to the viewer, depending on the viewing angle. An array of image elements overlaps the array of focusing structures and represent elongate image slices of at least two respective images. Depending on the viewing angle one of the at least two images is shown to the viewer. Due to the large print line widths involved, this type of simple open lenticular lens technology displays a poor performance, given it does not display sophisticated images or feature movement. This document contemplates the use of magnetic ink in the image array, and further envisages the incorporation of a separate magnetic material layer. However, it fails to disclose any magnetic ink layer separate from its image array.

GB2547045 describes a security device comprising a partial opaque layer comprising a plurality of light transmissive regions surrounded by one or more opaque regions. The light transmissive regions define negative indicia which are visible when the security device is viewed in transmission but not in reflection. The security device further comprises a low optical density layer which is semi-transparent in the visual spectral region is provided within the light transmissive regions. Similarly to GB2536877 this construct is simple and provides a poor performance, with limited scope for customisation.

EP319157 describes a security element made from a transparent plastic film provided with a continuous reflective metal layer, such as aluminium, formed by vacuum deposition. The metal layer is partially demetallized to provide clear demetallized regions that form indicia. The element, when wholly embedded in the substrate is barely visible in reflected light, but when viewed in transmitted light the indicia can be clearly seen highlighted against the dark background of the metallized area of the security element and adjacent areas of the paper.

EP2209944 describes a security element with public recognition features, which comprises a light transmitting carrier substrate, a metal layer that contains substantially metal-free areas that define indicia that are visible in transmitted light, and a further partial first light scattering layer providing further indicia which are visible in reflected light. The light scattering layer and the metal layer can overlap.

EP0428779 describes a security element which is magnetically readable, providing an identification code for documents. The identification code can be concealed within a security document or can be optically visible.

EP2229286 describes a security element comprising a first substrate which is at least partially opaque when viewed in transmitted light, as well as magnetic areas deposited on the substrate. Different types of magnetic areas, possessing different coercivity values, and whose magnetism therefore varies generates different codes, that are not detectable by normal instruments for detecting current magnetic codes in security threads.

As the technology evolves, and devices for duplicating security elements become more sophisticated, there is a need for increasingly more secure elements that are resistant to reproduction. Thus, there remains a need in the art for a security element for use in a security document which addresses the problems associated with the prior art security features and which affords enhanced anti-counterfeiting protection to security documents, whilst also providing an aesthetically pleasing appearance.

### SUMMARY OF INVENTION

According to a one aspect of the invention there is provided a security element, comprising:
an optic layer;
a metallic layer; and
a printed magnetic ink layer,
wherein the optic layer comprises:
   a micro-lens layer comprising a plurality of micro-lenses; and
   a micro-image layer comprising a plurality of micro-images,
wherein the micro-images are located at or near to the focal length of the micro-lenses.

By “near to” is preferably meant that the shortest distance between the micro-images and the micro-lenses is +20%, preferably +10%, more preferably +5%, and most preferably +2% of the focal length of the micro-lenses.

The security element may further comprise a photoluminescent layer.

It is well known in the art that the strongest security effect is best achieved by the combination of multiple security features. For example, if one security feature is destroyed or counterfeited, the remaining security features may be extant. In addition, the more security features present, the harder it is to counterfeit the item. The security element of the present invention combines multiple different security features, for example a metallic luster, negative text, magnetic print, coded magnetic print, fluorescent effects, and optical effects. This combination of security features provides greater anti-counterfeiting protection, an improved aesthetic character, as well as the ability to customise the appearance depending on the requirements of the security document, for example banknote denomination.

Preferably, the metallic layer is provided as a printed metallic ink layer.

The inventors of the present invention have surprisingly found that the use of a printed metallic ink layer has advantages in terms of aesthetics in the current inventive product over alternative metallic layers such as those provided by smooth vacuum metallisation. Specular reflection from a smooth vacuum metallised layer tends to degrade the aesthetic effect of the optical feature in the security element considered here. Conversely, a printed metallic ink layer has been found to have reduced specular reflection. This benefit therefore avoids the typical holographic-type effect afforded by smooth vacuum metallised layers of prior art constructions.

Alternatively, the metallic layer may be provided as a vacuum metallised layer on a profiled surface. The profiled surface may be a printed ink layer or a primer substrate suitable for the purpose. Crucially, the profiled surface is “rough” and has increased light-scattering properties, thus specular reflection is limited, and an improved aesthetic effect is achieved.

Print patterning of the printed metallic ink layer (or demetallisation of the vacuum metallised layer) can yield one or more regions where the metallic appearance of the layer is absent, these regions may give rise to images e.g., a negative text feature, in or on the security element which is visible in transmission or reflection. The appearance of the printed metallic ink layer can be altered through tinting with different coloured dyes or pigments. For example, where a silver-coloured ink is used in the printed metallic ink layer, tinting with a yellow dye provides a metallic ink layer with a golden appearance. Alternatively, colour may be added to a vacuum metallised layer using a semi-transparent tinted layer.

The security element according to the invention comprises a printed magnetic ink layer. Preferably, the magnetic ink is opaque. The incorporation of a magnetic machine-readable feature, which can be in the form of readable text or an image, into the security element provides added security, and makes reproduction far harder, whilst also providing a means for embedding information into the security element. Further, the use of an opaque feature, in this case the magnetic ink, in the embedded side of the security element for visual security of a security document is not commonly used. Rather, security elements in the prior art typically include a semi-transparent text feature, as in EP2209944. In this way, the perceived disadvantage of using an opaque magnetic ink is used to provide even further security through an additional visual feature.

Consequently, in the security element of the invention, the printed magnetic ink layer is preferably provided with one or more images (which may be in the form of text or code), which may be machine-readable owing to their magnetism even when the printed magnetic ink layer is optically obscured.

Alternatively (or as well), when the printed magnetic ink layer is not (or not wholly) optically obscured, the images may be complementary with the micro-images and/or with any image(s) in the metallic layer, respectively observable from opposite sides of the security element.

Each of the layers identified in the statement of invention are discrete layers, and therefore the printed magnetic ink layer and the micro-image layer are provided as separate layers in the security element according to the invention. Although, as discussed below, it is contemplated to provide images in the printed magnetic ink layer (and/or the metallic layer) there nevertheless remains a discrete micro-image layer. The micro-images may themselves be printed with, or partly with, magnetic ink if so desired, but even if so there remains in the security element of the invention discrete layers as aforesaid. Certain prior art, in particular GB2536877, concerns image print that is also magnetic, but the impracticality of incorporating sufficient magnetic material into an image print layer (i.e. the “micro-image layer” in the language of the present specification) to permit detection by, for example, bank note sorting machinery, without unduly limiting the type of image thereby available for production/resolution has prevented satisfactory commercialisation of such structures. The use of a printed magnetic ink layer discrete from a micro-image layer in the security element of the invention renders the element readily detectable by conventional banknote sorting machinery, without compromising the sophistication of the imagery that can be presented by the optic layer.

Further security, relative to security elements of the prior art, can achieved by varying the coercivity of the magnetic materials, as is a known option in currency magnetic features security, as described in EP0428779. Further magnetic code arrangements are described in EP2588996 and EP2229286, where overlapping magnetic prints of different coercivities enables multiple code readouts.

In a preferred embodiment, the magnetic layer may comprise a mixture of high- and low-coercivity magnetic materials. Advantageously, a mixture of coercivities enhances the machine-readability and encoding of more varied information.

The security element according to the invention comprises an optic layer. The optic layer comprises a micro-lens layer comprising a plurality of micro-lenses, and a micro-image layer comprising a plurality of micro-images. The micro-images are located at or near to the focal length of the micro-lenses.

In particular embodiments of the invention, the micro-lenses are spherical or lenticular lenses. Advantageously, this arrangement results in variable appearance of the image depending on the viewing angle and means that the security element is able to display sophisticated images, which may further feature movement effects, such as cinemagraphic effects.

According to another aspect of the invention there is provided the use of the security element in a security document.

Incorporation of the security element in a security document greatly enhances the security and anti-counterfeiting properties of the document.

According to another aspect of the invention there is provided a security document, comprising the security element and a substrate.

In the description that follows, it will be understood that all features relating to one aspect of the invention may also apply, where appropriate, to all other aspects of the invention and vice versa.

### DETAILED DESCRIPTION

The security element of the present invention involves a combination of layers, namely an optic layer, a metallic layer, a printed magnetic ink layer, and optionally a photoluminescent layer.

Preferably, the metallic layer is a printed metallic ink layer.

The printed metallic ink layer may comprise one or more regions where the metallic ink is absent. The one or more regions where the metallic ink is absent may give rise to images in or on the security element i.e., negative images which may be negative text. In the context of the present invention, the term “image” may refer to a pictorial image or shape, lettering, text, indicia, or the like. The negative images are preferably visible to the user in transmission.

The metallic ink may, for example, be silver-coloured, gold-coloured, copper-coloured, bronze-coloured etc. The metallic colour may be achieved using metal pigment, for example aluminium pigment may be used for a silver-coloured ink. The metallic ink adds a metallic luster effect to the security element with reduced specular reflectance, thus avoiding a holographic-type effect in the final product. This reduced specular reflectance may differentiate the security element visually, thereby increasing the counterfeit resistance and increasing the overall security level of the product compared to holographic-type products.

The printed metallic ink layer may be tinted with a dye or pigment to alter the appearance of the layer. For example, a yellow dye may be used to tint a silver-coloured ink, turning the layer a golden colour. Other dye/pigment colours may be used to allow further co-ordination with, for example, the denomination of a banknote or a specific print design.

The printed metallic ink layer may additionally comprise a fluorescent material. The fluorescent material may be a part of the dye/pigment used to tint the printed metallic ink layer. The versatility afforded through tinting of the metallic layer provides a further advantage to the present invention, allowing tailoring of the invention for different uses.

In addition to additional UV fluorescence pigments, magnetic pigments may be added to the printed metallic ink layer. For example, high coercivity (HiCo) or low coercivity (LoCo) magnetic pigments may be added. The magnetic pigments may be complimented by a magnetic text layer, in such a manner that they work cooperatively with one another. Advantageously, addition of one of these pigments, e.g. HiCo in the metallic ink, coupled with a separate LoCo pigment in a separate visible magnetic text layer may work cooperatively with one another to give a “TMC”-type (Three Magnetic Code) system, which may be read by a computer, adding an additional level of complexity and sophistication to the security element. Such a construct is described in EP2414176B1 and EP2588996B2, which are incorporated herein by reference.

Alternatively, the printed metallic ink layer may comprise other security feature pigments, which may include, but not limited to, IR Up/Down pigment converters.

IR up-conversion pigments comprise phosphors that convert infrared light into visible light. Normally, materials that fluoresce are down conversion particles that absorb energy at a higher level (UV) and emit energy at a lower level (visible). IR up-conversion pigments comprise a very rare class of inorganic crystals that can absorb multiple photons at a lower energy level and emit one photon at a higher energy level. The up-conversion process is also called an “anti-stokes shift”.

IR down-conversion pigments convert visible or infrared light to another infrared frequency. Down conversion refers to a material that absorbs light at a higher energy (shorter wavelength) and emits light at a low energy wavelength (longer wavelength). Typically, most materials that fluoresce will exhibit down conversion because the energy is flowing from a higher level to a lower level. To fluoresce, a material must absorb energy at one wavelength which temporarily bumps some of its electrons to a higher energy orbit. When the electrons fall back to their normal energy level, a photon is emitted which is the fluorescence.

Alternatively, the metallic layer may be provided as a vacuum metallised layer on a profiled surface. The profiled surface may be a printed ink layer or a primer substrate suitable for the purpose. The profiled surface is “rough” and has increased light-scattering properties, thus specular reflection is limited, and an improved aesthetic effect is achieved.

Consequently, the metallic layer is preferably diffusely reflective.

The diffuse reflectivity required may conveniently be provided by particulate materials (whether they be metallic ink materials or profiled surface materials, such as printed ink or primer materials) having an average aspect ratio (1:w—wherein “1” and “w” are respectively the first and second largest dimensions of each particle) of at least 2:1 and/or an average length (1) of at least about 0.5 μm, at least about 1 μm, at least about 1.5 μm or at least about 2.0 μm; or from about 0.5 μm to about 10 μm, or example from about 2 μm to about 5 μm.

The vacuum metallised layer may comprise one or more demetallized regions. The one or more demetallized regions may give rise to images in or on the security element i.e., negative images which may be negative text.

A semi-transparent tinted layer may be applied over the vacuum metallised layer to alter the appearance of the layer.

The security element further comprises a printed magnetic ink layer.

The printed magnetic ink layer may comprise images printed with magnetic ink.

Again, in the context of the invention, the term “image” may refer to a pictorial image or shape, lettering, text, indicia, or the like. The magnetic ink-printed images may be inset in register with the negative text of the metallic layer such that they do not overlap.

The magnetic ink may have a remanent band magnetic flux of 30 nWb/m or greater, 50 nWb/m or greater, 120 nWb/m or greater, or 150 nWb/m or greater.

The magnetic ink may be semi-transparent or opaque. Preferably, the magnetic ink is opaque.

The printed magnetic ink layer may be machine readable in that it contains a magnetic code, which can be read by a machine. By magnetic “code” it is preferably meant a system for communication of hidden information, for example secret information, in which the meaning of said information is conveyed using machine readable elements but is unintelligible by casual viewing of the security element. The printed magnetic ink layer is preferably compatible with commercially used detectors, such as note sorting machines.

Coercivity, also called magnetic coercivity, coercive field, or coercive force is a measure of the ability of a ferromagnetic material to withstand an external magnetic field without becoming demagnetized. The higher the coercivity level of the printed magnetic ink layer, the stronger the magnetic field has to be to change the data contained within the security element. This increases resistance and makes them more durable as they're less likely to be unintentionally erased or demagnetize when in proximity to other magnets. Lower coercivity printed magnetic inks are best for short-term applications, as the low-intensity magnetic field makes it easier to erase and change the ink's data, which also subsequently increases the risk of damage if placed by another magnetic field.

In some embodiments, the printed magnetic ink layer may comprise at least two types of magnetic areas which have different coercivity values and whose residual magnetism is identical or different, said different values being adapted to generate codes.

The printed magnetic ink layer may be directly applied to the metallic layer. However, in some instances, a barrier coating may be provided between the printed magnetic ink layer and the metallic layer to reduce/prevent unwanted galvanic corrosion effects between the materials involved. Where the metallic layer is a vacuum metallised layer, it is particularly preferable to include such a barrier coating. Additionally, or alternatively, the magnetic ink may comprise anti-corrosion additive(s).

In some instances, the magnetic ink-printed images may be visible from the surface applied/embedded side of the security element i.e., when used in a security document. This may provide additional visual security to the security document. In such instances, the magnetic ink-printed images may be visualised backside as a text or image readable to the user.

Alternatively, one or more additional layers may be provided (directly or indirectly) over the printed magnetic ink layer, covertly hiding the magnetic layer. The one or more additional layers may obscure the magnetic print so that it is not visible from the surface applied/embedded side of the security element but is still machine readable. The additional layer(s) may comprise one or more of an opaque masking layer, optionally a white opaque masking layer; an opaque print layer; a vacuum metallised layer; and/or a further polymeric layer, for example a polyethylene terephthalate (PET) layer.

Many advantages in terms of enhanced security and anti-counterfeiting can be realised when using a printed magnetic ink layer as described. As a specific example where the security element is used in a banknote, the magnetic ink-printed images may be matched to the denomination of the printed banknote, thereby integrally securing the banknote substrate directly—a counterfeiter would have to destroy the banknote substrate to remove the security element and its magnetic print.

As is known in the art, further security can be provided by adding different coercivity magnetic materials to the printed magnetic ink layer, as is a normal option in currency magnetic features security. Detection of different coercivity features is generally described in EP0428779.

The security element may further comprise a photoluminescent layer.

The photoluminescent layer may be located between the metallic layer and the printed magnetic ink layer. Alternatively, the printed magnetic ink layer may be located between the metallic layer and the photoluminescent layer.

The photoluminescent layer may comprise a fluorescent or luminescent material, or a material that is otherwise responsive to light. Preferably, the photoluminescent layer comprises a fluorescent material. The photoluminescent layer may be tinted with a dye or pigment. For example, the photoluminescent layer may be tinted with a blue or yellow dye.

The photoluminescent layer may be transparent, semi-transparent, or opaque depending on the specific requirements of the security element/document.

Where the photoluminescent layer is transparent, the metallic layer may be visible through the surface applied/embedded side of the security element i.e., when used in a security document. For example, the silver- or gold-colour of the metallic layer may be visible through the surface applied/embedded side of the security element to give a pleasing appearance.

However, in other instances, the photoluminescent layer may be tinted with a pigment, for example a standard white masking (or other) colour pigment, such that the photoluminescent layer is opaque. This may allow the security element to be fully hidden when embedded in a security document. For example, an opaque white photoluminescent layer may allow the security element e.g., in the form of a security thread, to be fully hidden in the paper substrate of a security document, for example a banknote. Where the photoluminescent layer is opaque, the magnetic ink layer may be printed on top of the photoluminescent layer to retain its visibility.

The security element may further comprise an additional vacuum metallised layer i.e., additional to any vacuum metallised layer forming the “metallic layer”. The additional vacuum metallised layer may be smooth vacuum metallised—this gives the appearance of an opaque, metallic, specular surface. Alternatively, the additional vacuum metallised layer may be provided on a profiled (“rough”) surface—this gives the appearance of a white, non-specular surface.

The additional vacuum metallised layer may be provided directly or indirectly over the metallic layer, the printed magnetic ink layer or the photoluminescent layer (where present). Preferably, the additional vacuum metallised layer is provided over what would be the surface applied/embedded side of the security element i.e., when used in a security document. The presence of the additional vacuum metallised layer has the potential advantage of masking the surface applied/embedded side of the security element in the security document—this may be particularly advantageous when incorporating the security element into or onto a paper substrate.

The optic layer involves an optical element that provides visual effects to the user. The term “optical element” refers to elements and devices that focus light towards or cause light to constructively interfere at a real focal point, or devices placed in front of an image source to selectively reveal different portions of the image source. Optical elements include refractive elements that focus incoming light to a real focal point in a real focal plane and also collimate light scattered from any point in the focal plane to a particular direction.

The optic layer may comprise a micro-lens layer comprising a plurality of micro-lenses; and a micro-image layer comprising a plurality of micro-images, wherein the micro-images are located at or near to the focal length of the micro-lenses.

The micro-lenses may comprise lenticular, cylindrical, spherical and/or aspheric lenses. The micro-lenses may be concave or convex. A cylindrical lens is a lens which focuses light into a line instead of a point, as a spherical lens would. Cylindrical lenses have curvature along only one axis, and are used to focus light into a line, or to convert the elliptical light from a laser diode into a round beam. Aspheric lenses have at least one surface that is neither spherical nor cylindrical. These more complicated shapes allow such lenses to form images with less aberration than standard simple lenses, but they are more difficult and expensive to produce.

The optic layer may take the form of a lens array, such as a lenticular lens array (linear lenses) or an array of spherical, hexagonal, aspherical, or other-shaped lenses, that may be used to display an image printed on an opposite planar side of the transparent substrate of the lens array. The resulting displayed or visible image may be a three-dimensional (3D) image, an image that is animated with movement of the security document, or with differing viewing angles, an image provided by a full volume pixel map or moiré pattern, and/or an image providing other optical effects available through the use of lenticular, diffraction, and other optical technologies. Such optic layer technology is described in WO2024010868, the contents of which are incorporated herein by reference.

A lenticular lens is an array of lenses, designed so that when viewed from slightly different angles, different parts of the image underneath are shown, giving an illusion of depth. Thus, in some embodiments, the micro-lenses are lenticular lenses, more preferably spherical or cylindrical lenticular lenses. The micro-lenses may be formed of a high refractive index (RI) material or a low RI material, optionally a UV-curable acrylate polymer.

In a specific embodiment, the optic layer may comprise a virtual lens. A “virtual lens” may be formed by combining a plurality of lenses, and then pairing a set of interlaced image elements with each of these virtual lenses. The interlaced image elements may be spread throughout the lenses of the virtual lens or lens set by arranging the images or image elements in a non-sequential order, which is typically created through the use of a tracing algorithm or program.

A virtual lens may be uniquely configured to make use of sets of lenses in a lens array rather than requiring that all the interlaced image elements be printed under a single lens. Each set may be provided by groups of adjacent lenses. The interlacing of the adjacent frames is non-sequential in both directions or along the two orthogonal axes of the lens sets. The virtual lenses take selected images from the original lenses and places them in position in an interlaced image. In this manner, the group of lenses simultaneously focusses on the correct group of images.

Advantageously, virtual lenses overcome shortcomings in traditional lens interlacing where the relationship between the resolution, number of frames and lens size restricts the size of the construct. Virtual lenses facilitate the development of thinner lenses and thinner lenticular products, with greater resolution.

The micro-images may be ink printed images, optionally printed with a UV-curable ink.

One or more synthetic images and/or louvre images may be formed when the micro-images are viewed through the micro-lenses. The synthetic image(s) may be a moiré image and/or an integral image.

The synthetic image(s) may appear above and/or below the plane of the security element and may therefore give the impression of movement when the film is tilted, according to optical parallax principles. The synthetic image(s) may give the impression of being 2D or 3D. The synthetic image(s) may also comprise more than one object, for example appearing at different height/depth.

The synthetic image(s) that may be provided by the optic layer may result in a large variety of additional optical effects, for example animations, image flips, images with objects changing their general appearance upon tilting and/or rotating the security element, images in which one object controls the perception of another object, or images in which objects are moving in a non-physical manner.

In a particular embodiment, the synthetic image(s) that may be provided by the optical layer may result in cinemagraphic effects, such as the apparent movement of a synthetic image, for example, but not limited to, a bird flapping its wings. A cinemagraphic effect is a combination of a still image and a video, where most of the scene is stationary, while a section moves on a continuous loop. An example would be a bird flying through clouds, where the bird moves, but the clouds remain stationary.

The micro-lens layer may be exposed i.e., with no overcoat.

Alternatively, an overcoat may be provided over the micro-lens layer. An overcoat has the advantage of reducing or preventing soiling of the micro-lens layer in use and therefore helps to maintain optical performance of the optic layer. The overcoat may be formed of a high refractive index (RI) material or a low RI material, optionally a UV-curable acrylate polymer.

Where the micro-lenses are formed of a high RI material, the overcoat preferably comprises a low RI material. Conversely, where the micro-lenses are formed of a low RI material, the overcoat preferably comprises a high RI material. In either instance, the optic layer is fully compatible with conventional adhesives, as well as the fluorescent and magnetic features of the security element.

The optic layer may additionally comprise a base film layer positioned between the micro-lens layer and the micro-image layer. The base film layer may be transparent. The base film layer may comprise any suitable polymeric material, for example a polyester such as PET, or a polyolefin such as polypropylene and/or polyethylene.

The optic layer may further comprise a pick-up layer positioned between the base film layer and the micro-image layer. The pick-up layer may be formed of a UV-curable acrylate polymer. The pick-up layer may be printed with a UV-curable ink.

The micro-image layer may be produced using a method where an initial micro image array is embossed on the back of the substrate film corresponding to the micro-lens system by UV casting or pressure embossing. This emboss structure is then filled with ink and the excess removed, by doctor blade for example, leaving printed structure behind. This process may also be further developed by using materials with different surface tensions, such as using substrates and inks with different hydrophobic and hydrophilic responses, to improve print definition.

Alternatively, the micro-image layer may be produced in other conventional processes, such as, but not limited to, micro-casting, micro gravure printing, micro intaglio printing, hot embossing, self-assembly, inkjet printing, electrohydrodynamic jet printing, thermal reflow of photoresist, laser-based fabrication methods, wet etching, or soft lithography.

The security element may preferably further comprise an adhesive layer on one or both outer surfaces of the security element. For example, if the security element is designed for incorporation partially or wholly within a security document or document substrate, it is typically preferred to provide an adhesive layer on both sides of the element to ensure good retention within the document. Alternatively, if the security element is designed to be affixed to an outer surface of a document substrate, an adhesive layer may be provided on one side only. The adhesives could be contact pressure adhesives or heat activated adhesives, for example.

The security element may be a security thread, stripe, foil, patch or the like.

The present invention also provides use of a security element as described above in a security document.

The present invention also provides a security document comprising a security element as described above and a substrate. The security document is preferably, but not limited to, any of the following: a banknote, a passport, a license, an identification document, a visa, a permit, a cheque, a security label or a certificate.

The substrate may comprise a fibrous material, for example a cellulosic material such as paper; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

The security element may be surface applied to the substrate, or may be partially or wholly embedded in the substrate, optionally in a windowed fashion.

Where the security element is partially embedded in the substrate in a windowed fashion, the “windowed fashion” may be the security element weaving in and out of the substrate. In the specific example of a banknote, the security element may be a security thread that weaves in and out of the banknote film or paper such that some portions of the security thread are on the surface of the film/paper and some portions are embedded between layers of the film/paper—this is known in the art as a windowed security thread, and is described in EP0059056, the contents of which are incorporated herein by reference. A fully embedded security element is also possible, for example where the security element e.g., security thread, is provided entirely between layers of the film/paper substrate e.g., in a banknote.

If the security element is incorporated into substrate as described then this advantageously allows the magnetic print on the reverse side of the security element to be visible from the non-windowed side of the security document.

The surface applied security element may be a conventional stripe or patch.

Where the security element is surface applied to the substrate it may be in a “secure window” fashion. In other words, the security element may be surface applied over, at least a part of, an aperture in the substrate. Such “secure window” technology is described in EP3314335 and EP0723501, the contents of which are incorporated herein by reference.

Several advantages are realised when the security element is surface applied over an aperture in the substrate i.e., a secure window. The aperture in the substrate allows the security element to be viewed through the security document, thus the magnetic print and the negative images (negative text) may be visible through the security document. In addition, it is possible to add further security features, for example holograms, colour-shift features, and/or further optic features, preferably in register with, and so visible from the reverse side of the security document, the aperture in the substrate.

The invention will now be more particularly described with reference to the following figures and non-limiting examples:

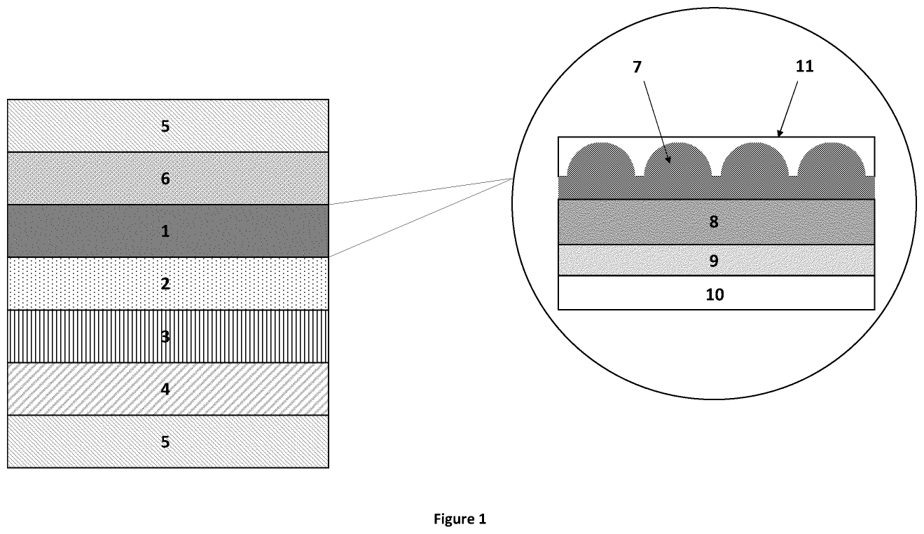

FIG. 1: a schematic diagram showing the structure of a security element in accordance with the present invention where the printed magnetic ink layer is located between the metallic layer and the photoluminescent layer

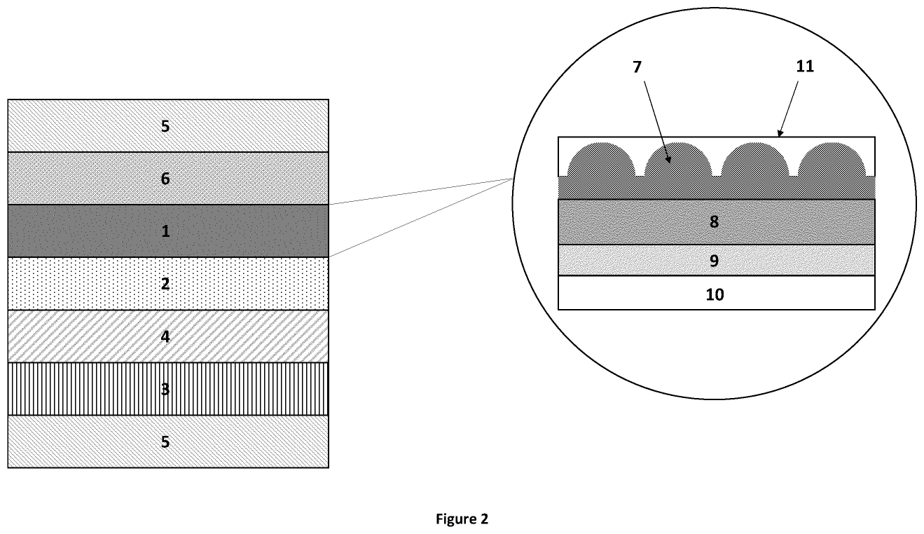

FIG. 2: a schematic diagram showing the structure of a security element in accordance with the present invention where the printed magnetic ink layer is located on the outside of the photoluminescent layer

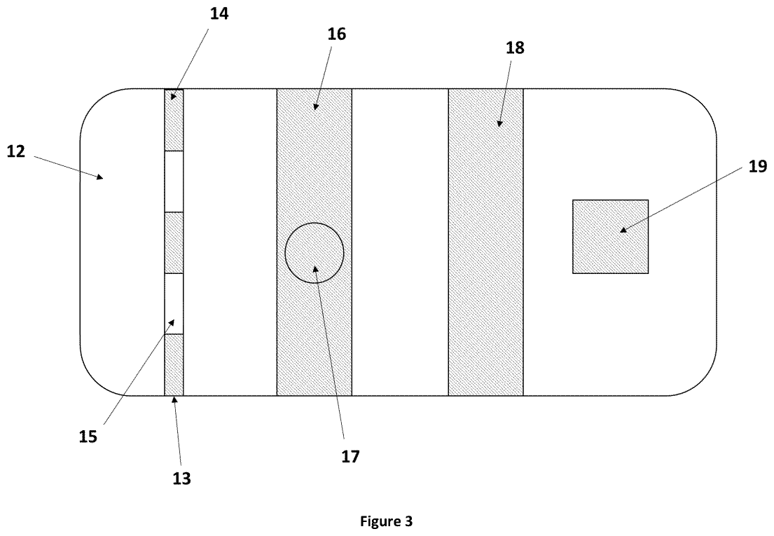

FIG. 3: a schematic diagram showing the various ways in which the security element can be incorporated into/onto a security document in accordance with the present invention

Referring to FIG. 1, the figure illustrates the structure of a security element in accordance with the present invention. The security element comprises a multi-layer construct. The optic layer (1) comprises a micro-lens layer (7), covered by an overcoat (11), which overlies a base film layer (8), a pick-up layer (9) and a micro-image layer (10). In this arrangement, the micro-lens layer (7) comprises a plurality of micro-lenses that are preferably spherical or cylindrical lenticular lenses. Micro-images (not shown) in the micro-image layer (10) are located at or near to the focal length of the micro-lenses.

One surface of the optic layer (1) is covered by an adhesive primer layer (6) and an adhesive layer (5), which facilitates integration of the security element into a security document. On the other surface of the optic layer there is provided a metallic layer (2), a printed magnetic ink layer (3), and a photoluminescent layer (4), overlaid with a further adhesive layer (5). In this arrangement, the metallic layer (2) is a printed metallic ink layer to which the printed magnetic ink layer (3) is directly applied. The printed metallic ink layer may have one or more regions where the metallic ink is absent, giving rise to images i.e., negative images (not shown).

Referring to FIG. 2, the figure illustrates the structure of an alternative security element in accordance with the present invention, where the printed magnetic ink layer (3) is located on the outside of the photoluminescent layer (4). The security element comprises a multi-layer construct. The optic layer (1) comprises a micro-lens layer (7), covered by an overcoat (11), which overlies a base film layer (8), a pick-up layer (9) and a micro-image layer (10). In this arrangement, the micro-lens layer (7) comprises a plurality of micro-lenses that are preferably spherical or cylindrical lenticular lenses. Micro-images (not shown) in the micro-image layer (10) are located at or near to the focal length of the micro-lenses.

One surface of the optic layer (1) is covered by an adhesive primer layer (6) and an adhesive layer (5), which facilitates integration of the security element into a security document. On the other surface of the optic layer there is provided a metallic layer (2), a photoluminescent layer (4), and a printed magnetic ink layer (3), overlaid with a further adhesive layer (5). In this arrangement, the metallic layer (2) is a printed metallic ink layer. The printed metallic ink layer may have one or more regions where the metallic ink is absent, giving rise to images i.e., negative images (not shown).

Referring to FIG. 3, the figure illustrates various ways in which the security element can be incorporated into/onto a security document in accordance with the present invention. The security document has a substrate (12). The first security element is a windowed security thread (13) which is partially embedded in the substrate (12) in a windowed fashion. The windowed security thread (13) weaves in and out of the substrate (12) such that some portions (14) are on the surface of the substrate and some portions (15) are embedded between layers of the substrate.

The second security element is a security stripe in a secure window arrangement. The security stripe (16) is surface applied to the substrate (12) over an aperture (17) in the substrate. The security stripe (16) is continuous over the substrate (12) and therefore can be viewed through the reverse side of the substrate through the aperture (17).

The third security element is a stripe (18) that is surface applied to the substrate (12).

The fourth security element is a patch (19) that is surface applied to the substrate (12).

### EXAMPLES

The invention will now be described in more detail with reference to the following non-limiting examples:

### Example 1

A security element having the structure outlined in FIG. 1 was produced. The metallic layer was printed with a silver-coloured metallic ink (pigmented with aluminium) such that there were regions where the ink was absent which gave rise to text i.e., negative text. The silver-coloured metallic ink was tinted with a (non-colouring) yellow fluorescent dye. A blue fluorescent dye was used in the photoluminescent layer. In daylight reflection, the front side of the security element appeared as a silver layer with variable optical features depending on the viewing angle. When held to the light and viewed in transmission, the negative text was clearly visible. The reverse side also appeared with a silver effect, with the negative text in reverse, but the optical features not visible. The magnetic printed text was clearly visible as opaque black text from the reverse side.

Under UV light in reflection, the front side appeared as a white fluorescence with blue fluorescent text. Without wishing to be bound by any such theory, it is believed that this unusual effect may be as a result of the metallic layer having a relatively low thickness and allowing the blue fluorescence to transmit through the metallic layer thereby mixing with the yellow fluorescence in the metallic layer producing white fluorescence.

Also, under some conditions, a yellow fluorescent text (observable front side) resulted from the blocking action provided by the black magnetic text on the reverse side. The back side appeared with an all over blue fluorescent appearance, with the black magnetic text clearly visible.

### Example 2

A security element having the structure outlined in FIG. 1 was produced. The metallic layer was printed with a gold-coloured metallic ink (provided by mixing the silver-coloured metallic ink with a yellow ink), such that there were regions where the ink was absent which gave rise to text i.e., negative text. The gold-coloured metallic ink was tinted with a yellow fluorescent dye. A blue fluorescent dye was used in the photoluminescent layer. In daylight reflection, the front side of the security element appeared as a gold layer with variable optical features depending on the viewing angle. When held to the light and viewed in transmission, the negative text was clearly visible. The reverse side also appeared with a gold effect, with the negative text in reverse, but the optical features not visible. The magnetic printed text was clearly visible as opaque black text. Under UV light in reflection, the front side appeared as a yellow fluorescence with contrasting blue fluorescent text. The back side appeared with an all over yellow fluorescent appearance, with fluorescent blue in the negative text areas and the black magnetic text clearly visible.

### Example 3

A security element having the structure outlined in FIG. 1 was produced. The metallic layer was printed with a gold-coloured metallic ink (provided by mixing the silver-coloured metallic ink with a yellow ink), such that there were regions where the ink was absent which gave rise to text i.e., negative text. A blue fluorescent dye was used in the photoluminescent layer. However, no fluorescent material was used in the metallic layer. In daylight reflection, the front side appeared as a gold layer with variable optical features depending on the viewing angle. When held to the light and viewed in transmission, the negative text was clearly visible. The reverse side also appeared with a gold effect, with the negative text in reverse, but the optical features not visible. The magnetic printed text was clearly visible as opaque black text. Under UV light in reflection, the front side appeared as under normal daylight transmission with contrasting blue fluorescent text. The back side appeared with fluorescent blue in the negative text areas and the black magnetic text clearly visible, on a golden background. This example is highlighted due to the surprising result of blue fluorescence in the negative text areas only.

### Example 4

The properties of the magnetic ink were tested. Magnetic inks were printed on to a substrate in a magnetic printed layer.

Low-coercivity magnetic Sicpa 67E276M ink was used for the creation of Positive Texts on the substrate. The properties of this ink are described in Table 1. The magnetic ink used, was Sicpa 67E276M with a composition as described in Table 1, below:

| Property | Appearance |
|---|---|
| Aspect | Black Liquid |
| Coercivity | 275 Oe ± 25 Oe (Measured at 3000 ± Oe) |
| Solid Contents | 66 wt % ± 4 wt % |
| Viscosity at 23° C. | Delivered at 20″ DIN6 ± 2″ |
| Dilution on Printing Press | Ethyl acetate |
| Additives | Retarder (N-propylacetate) |
| | Accelerator (Ethyl acetate) |
| Cleaning | Ethyl acetate |
| Light Fastness (IWS Blue | 5 |
| Scale 1-8) | |
| Shelf Life | 6 months |

The magnetic ink is composed of iron oxide with a declared coercivity of 275 Oe+/−25 Oe. An alternative magnetic ink was also used, further comprising an anti-blocking component, in this instance the magnetic ink was 67E309M, which comprises iron oxide with a coercivity of 295 Oe+/−30 Oe.

For the implementation of the product, a high-coercivity magnetic ink was also introduced to the magnetic printed layer, using a magnetic 66E3513M ink composed of barium oxide with a coercivity of 3500 Oe+/−300 Oe.

In another example, a combination ink comprising both high and low coercivity elements was used. This magnetic ink is called 67E560M and comprises a mixture of barium oxide with a coercivity of 3500 Oe+/−300 Oe and iron oxide with a coercivity of 295 Oe+/−30 Oe.

1-36. (canceled)

37. A security element comprising:
an optic layer;
a metallic layer; and
a printed magnetic ink layer,
wherein the optic layer comprises:
a micro-lens layer comprising a plurality of micro-lenses; and
a micro-image layer comprising a plurality of micro-images,
wherein the micro-images are located at or near to the focal length of the micro-lenses.

38. The security element according to claim 37, wherein the metallic layer is diffusely reflective.

39. The security element according to claim 37, wherein the metallic layer is a printed metallic ink layer; optionally
wherein the printed metallic ink layer comprises one or more regions where the metallic ink is absent which give rise to images in or on the security element; and/or
wherein the printed metallic ink layer is silver-coloured, gold-coloured, copper-coloured, or bronze-coloured.

40. The security element according to claim 39, wherein the printed metallic ink layer is tinted with a dye or pigment.

41. The security element according to claim 39, wherein the printed metallic ink layer comprises a fluorescent material.

42. The security element according to claim 37, wherein the metallic layer is a vacuum metallised layer on a profiled surface; optionally
wherein the vacuum metallised layer comprises one or more demetallised regions which give rise to images in or on the security element; and/or
wherein a semi-transparent tinted layer is applied over the vacuum metallised layer.

43. The security element according to claim 39, wherein the metallic ink or profiled surface comprises particulate materials having an average aspect ratio (1:w—wherein “1” and “w” are respectively the first and second largest dimensions of each particle) of at least 2:1 and/or an average length (l) of at least about 0.5 μm, at least about 1 μm, at least about 1.5 μm or at least about 2.0 μm; or from about 0.5 μm to about 10 μm, or from about 2 μm to about 5 μm.

44. The security element according to claim 37, wherein the magnetic ink layer comprises images printed with magnetic ink; optionally
wherein the images in the magnetic ink layer are in register with images in the metallic ink layer, optionally without overlapping them; and/or
wherein the magnetic ink has a remanent band magnetic flux of 30 nWb/m or greater, 50 nWb/m or greater, 120 nWb/m or greater, or 150 nWb/m or greater.

45. The security element according to claim 44, wherein the magnetic ink is opaque.

46. The security element according to claim 37, wherein one or more additional layers are provided over the printed magnetic ink layer to obscure the magnetic print; optionally
wherein the additional layers are selected from one or more of an opaque masking layer, optionally a white opaque masking layer; an opaque print layer; a vacuum metallised layer; and/or a further polymeric layer, for example a polyethylene terephthalate (PET) layer.

47. The security element according to claim 37, further comprising a photoluminescent layer; optionally
wherein the photoluminescent layer comprises fluorescent material; optionally
wherein the photoluminescent layer is tinted with a dye or pigment; optionally
wherein exposure to UV radiation causes fluorescence from the photoluminescent layer to transmit through the metallic layer and mix with fluorescence from the metallic layer to produce a different colour fluorescence, optionally white fluorescence.

48. The security element according to claim 37, further comprising an additional vacuum metallised layer, optionally provided directly or indirectly over the metallic layer, the printed magnetic ink layer or the photoluminescent layer; and/or
wherein the micro-lenses are spherical or lenticular lenses, optionally wherein the micro-lenses are spherical lenses; optionally
wherein the micro-images are ink printed images.

49. The security element according to claim 48, wherein one or more synthetic images and/or louvre images are formed when the micro-images are viewed through the micro-lenses, optionally wherein the synthetic images are moiré images and/or integral images.

50. The security element according to claim 48, wherein the optic layer additionally comprises one or more of the following:
an overcoat provided over the micro-lens layer;
a base film layer positioned between the micro-lens layer and the micro-image layer; and/or
a pick-up layer positioned between the base film layer and the micro-image layer.

51. The security element according to claim 37, further comprising an adhesive layer on one or both outer surfaces of the security element; and/or
wherein the security element is a security thread, stripe, foil or patch.

52. Use of a security element according to claim 1 in a security document.

53. A security document comprising a security element according to claim 1 and a substrate.

54. The security document according to claim 53, wherein the substrate comprises a fibrous material, optionally paper.

55. The security document according to claim 53, wherein the security element is surface applied to the substrate, or partially or wholly embedded in the substrate, optionally in a windowed fashion; optionally
wherein the security element is surface applied over, at least a part of, an aperture in the substrate; optionally
wherein one or more further security features are applied to the side of the aperture opposite to the security element, optionally in register with the aperture; optionally
wherein the further security features are selected from one or more of holograms, colour-shift features and/or further optic features.

56. The security document according to claim 53, wherein the security document is a banknote, a passport, a license, an identification document, a visa, a permit, a cheque, a security label or a certificate.
